(19) United States
(12) Patent Application Publication
(10) Pub. No.: US 2025/0282295 A1
(43) Pub. Date: Sep. 11, 2025

(54) ACCESSORY PORT AND ACCESSORY FOR VEHICLES

(71) Applicant: Rivian IP Holdings, LLC, Irvine, CA (US)

(72) Inventors: Daniel Geoffrey WALKER, Dana Point, CA (US); Austin Lee FREDERICKSON, Carlsbad, CA (US); Steven Digby NICOL, San Clemente, CA (US); Matthew MATERA, Newport Beach, CA (US); Kaitlyn Noel OLAH, Irvine, CA (US)

(21) Appl. No.: 19/047,526

(22) Filed: Feb. 6, 2025

Related U.S. Application Data
(60) Provisional application No. 63/562,209, filed on Mar. 6, 2024.

(51) Int. Cl. B60R 9/052

(52) U.S. Cl. CPC B60R 9/052

(57) ABSTRACT

A crossbar for a vehicle may include a latch mechanism that provides a latch force that is maintained across various mounting conditions and/or changes in the mounting conditions. In various implementations, the latch mechanism is provided with a spring assembly coupled to a pawl this actuatable to releasably secure the crossbar to the vehicle.

### CROSS REFERENCE TO RELATED APPLICATIONS

This application claims the benefit of priority to U.S. Provisional Patent Application No. 63/562,209, entitled, “Accessory Port And Accessory for Vehicles”, filed on Mar. 6, 2024, the disclosure of which is hereby incorporated herein in its entirety.

### INTRODUCTION

Accessory ports and accessories are provided for vehicles.

### SUMMARY

The present description relates generally to an accessory port and an accessory for a vehicle. The accessory port may include a mechanical connector on a roof or a truck bed of a vehicle, and the accessory may be a crossbar, which also may be referred to herein as a rack, a roof rack, or a roof rack mount.

According to aspects of the disclosure, a crossbar for a vehicle is provided, the crossbar including a pawl configured to interact with a striker bar of a mechanical connector on the vehicle to releasably secure the crossbar to the mechanical connector; and a spring assembly mechanically coupled to the pawl and configured to provide a latching force tolerance for the pawl to releasably secure the crossbar to the mechanical connector. The crossbar may also include one or more sealing features configured to form a seal with the mechanical connector when the crossbar is mounted to the mechanical connector. The latching force tolerance may maintain a latching force for the pawl over a range of configurations of the one or more sealing features.

The one or more sealing features may include an outer sealing feature configured to form a first seal between the mechanical connector and an outermost surface of the crossbar, and an inner sealing feature configured to form a second seal between the striker bar of the mechanical connector and another surface of the crossbar.

The spring assembly may include a spring and screw assembly.

The spring assembly may include a leaf spring. The pawl may include a first portion and a second portion separate from the first portion, and the leaf spring may couple the first portion of the pawl to the second portion of the pawl.

The crossbar may also include a locking structure and an additional spring that biases the locking structure into a locked position that holds the pawl in a latched configuration. The crossbar may also include a paddle for controlling a latch mechanism comprising the pawl, the spring assembly, the locking structure, and the additional spring. Moving the paddle when the pawl is in the latched configuration moves a protrusion on a structure that is mechanically coupled to the paddle into contact with the locking structure to push the locking structure away from the locked position, compressing the additional spring, until the pawl is released into an unlatched configuration. The spring assembly may be further configured to allow a latch comprising the pawl to be latched and unlatched using a constant force over a range of the latch.

According to other aspects of the disclosure, a vehicle is provided that includes a mechanical connector having a striker bar; and a crossbar that includes a latch mechanism. The latch mechanism may include a pawl configured to interact with the striker bar of the mechanical connector to releasably secure the crossbar to the mechanical connector, and a spring assembly mechanically coupled to the pawl and configured to provide a latching force tolerance for the pawl to releasably secure the crossbar to the mechanical connector.

The vehicle may also include the mechanical connector mounted to a roof or a truck bed of the vehicle. The crossbar further may also include one or more sealing features configured to form a seal with the mechanical connector when the crossbar is mounted to the mechanical connector, wherein the latching force tolerance maintains a latching force for the pawl over a range of configurations of the one or more sealing features.

The spring assembly may include a die spring and screw assembly.

The spring assembly may include a leaf spring. The pawl may include a first portion and a second portion separate from the first portion, and the leaf spring may couple the first portion of the pawl to the second portion of the pawl. The latch mechanism may also include a locking structure and an additional spring that biases the locking structure into a locked position that holds the pawl in a latched configuration.

The crossbar may also include a paddle for controlling the latch mechanism that includes the pawl, the spring assembly, the locking structure, and the additional spring. Moving the paddle when the pawl is in the latched configuration moves a protrusion on a structure that is mechanically coupled to the paddle into contact with the locking structure to push the locking structure away from the locked position, compressing the additional spring, until the pawl is released into an unlatched configuration. The spring assembly may be further configured to allow a latch comprising the pawl to be latched and unlatched using a constant force over a range of the latch.

According to other aspects of the disclosure, a latch mechanism for a crossbar for a vehicle is provided, the latch mechanism including a pawl configured to interact with a striker bar of a mechanical connector on the vehicle to releasably secure the crossbar to the mechanical connector, and a spring assembly mechanically coupled to the pawl and configured to provide a latching force tolerance for the pawl to releasably secure the crossbar to the mechanical connector. The pawl may include a first portion and a second portion separate from the first portion, and wherein a leaf spring couples the first portion of the pawl to the second portion of the pawl.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic side views of example implementations of a vehicle having crossbars mounted thereto in accordance with one or more implementations.

FIGS. 2A and 2B illustrate schematic perspective views of example implementations of a vehicle having crossbars mounted thereto in accordance with one or more implementations.

FIG. 3 illustrates a side view of an example crossbar in accordance with one or more implementations.

FIG. 4 illustrates a side view of another example crossbar in accordance with one or more implementations.

FIG. 5 illustrates a cross-sectional side view of an example implementation of a crossbar in accordance with one or more implementations.

FIG. 6 illustrates a cross-sectional side view of another example implementation of a crossbar in accordance with one or more implementations.

FIG. 7 illustrates a cross-sectional side view of yet another example implementation of a crossbar in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to an accessory port and an accessory for a vehicle, such as an electric vehicle.

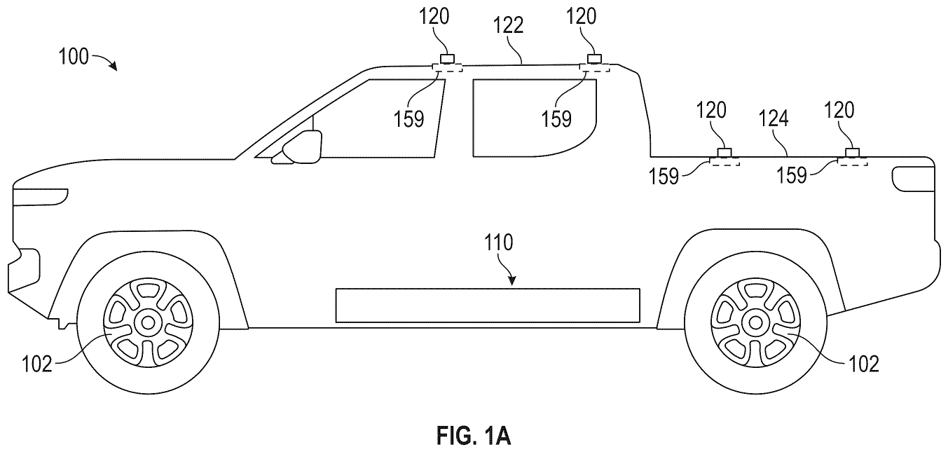

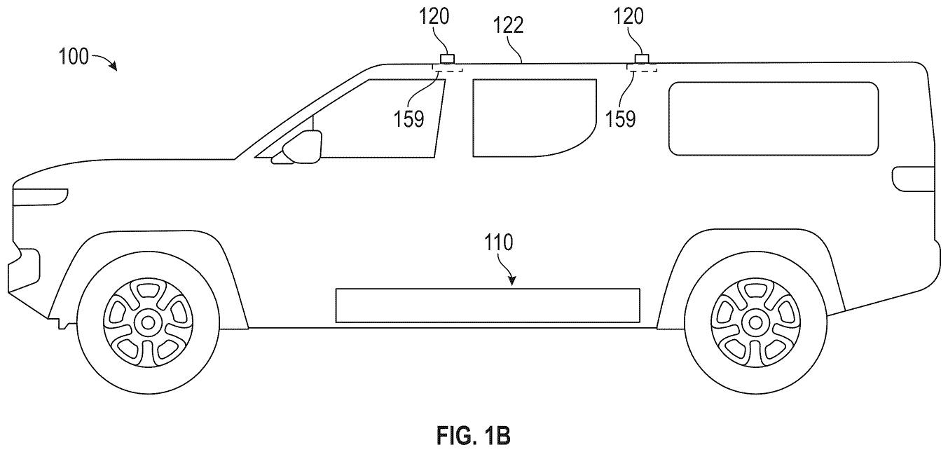

FIG. 1A is a diagram illustrating an example implementation of an apparatus as described herein. In the example of FIG. 1A, the apparatus includes a moveable apparatus implemented as a vehicle 100. As shown, the vehicle 100 may include one or more batteries 110. The battery 110 may be coupled to an electrical system of the vehicle 100, to receive power for charging of the battery and/or to provide power to one or more electronic components of the vehicle electrical system.

In one or more implementations, the vehicle 100 may be an electric vehicle having one or more electric motors that drive the wheels 102 of the vehicle using electric power from the battery 110. The battery 110 may include one or more battery modules, which may include one or more battery cells, or may be provided without any battery modules (e.g., in a cell-to-pack configuration). In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having a roof 122 and a truck bed 124.

As shown, the vehicle 100 may include one or more respective mechanical connectors 159 (e.g., accessory ports). For example, the mechanical connectors 159 may be disposed on and/or embedded within the roof 122 of the vehicle 100, and/or on a surface or a wall of the truck bed 124 of the vehicle 100.

In the example of FIG. 1A, two mechanical connectors 159 are visible on the roof 122 of the vehicle 100 (e.g., at or near the left side of the vehicle that is visible in FIG. 1A). In one or more implementations, two additional mechanical connectors 159 may be symmetrically disposed on the roof 122 of the vehicle 100, such as at or near the right side of the vehicle that is not visible in FIG. 1A. In such implementations, the roof 122 of the vehicle 100 may include four mechanical connectors 159. As shown in FIG. 1A, in one or more implementations, the vehicle 100 may (e.g., in addition to and/or instead of one or more of the mechanical connectors 159 on the roof 122 of the vehicle) include one or more mechanical connectors 159 on or near a wall of the truck bed 124 of the vehicle.

As shown in FIG. 1A, one or more crossbars 120 may be mounted to the vehicle 100 using the mechanical connectors 159. For example, each of the crossbars 120 may be removably mounted to one or more of the mechanical connectors 159. For example, each crossbar 120 may be removably mounted to two mechanical connectors on opposing sides of the roof 122 or the truck bed 124.

In the example of FIG. 1A, the crossbars 120 are mounted to the mechanical connectors 159 of a vehicle 100 implemented as a pickup truck. However, in one or more other use cases, the crossbars 120 and the mechanical connectors 159 may be mounted to another type of vehicle. For example, FIG. 1B illustrates another use case in which the vehicle 100 including the battery 110, the mechanical connectors 159, and the crossbars 120 is implemented as a sport utility vehicle (SUV), such as an electric sport utility vehicle. In the example of FIG. 1B, the vehicle 100 may include a cargo storage area in at least a rear portion of the vehicle that is enclosed within the vehicle 100 (e.g., behind a row of seats within a cabin of the vehicle). As shown, in this example, the vehicle 100 may include two mechanical connectors 159 located on a left side of the roof 122 of the SUV. One or more (e.g., two) additional mechanical connectors 159 may also be provided (e.g., symmetrically with the two mechanical connectors 159 on the left side of the roof 122 of the vehicle) on a right side of the roof 122 of the vehicle. In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having mechanical connectors for crossbars.

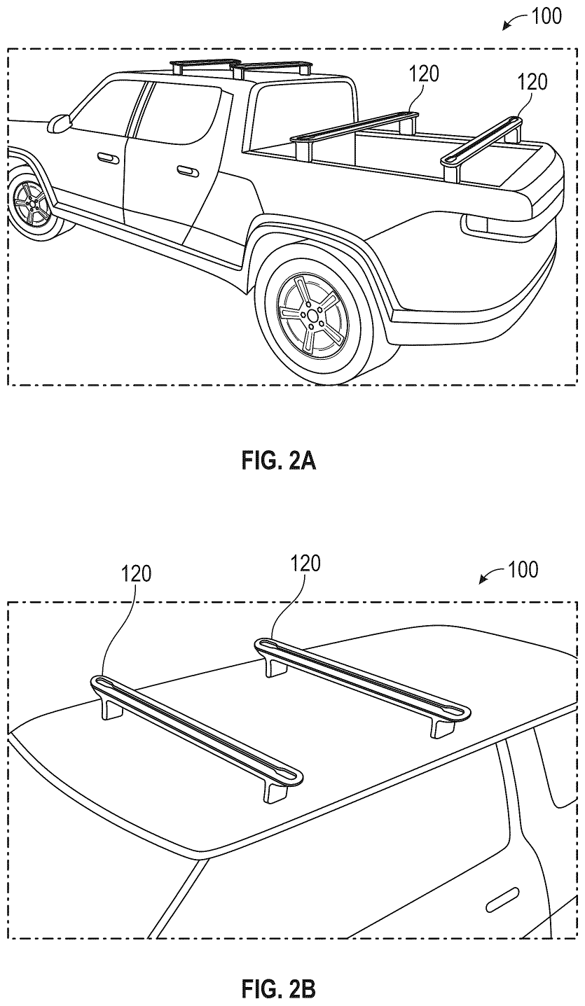

FIG. 2A illustrates a perspective view a vehicle 100 implemented as a pickup truck as in FIG. 1A, and showing how the crossbars 120 may extend across the width of the vehicle and be mounted at or near opposing sides of the vehicle (e.g., mounted to the mechanical connectors 159 on the opposing sides of the vehicle). FIG. 2B illustrates a perspective view a vehicle 100 implemented as an SUV as in FIG. 1B, and showing how the crossbars 120 may extend across the width of the vehicle and be mounted at or near opposing sides to the vehicle (e.g., mounted to the mechanical connectors 159 on the opposing sides of the vehicle).

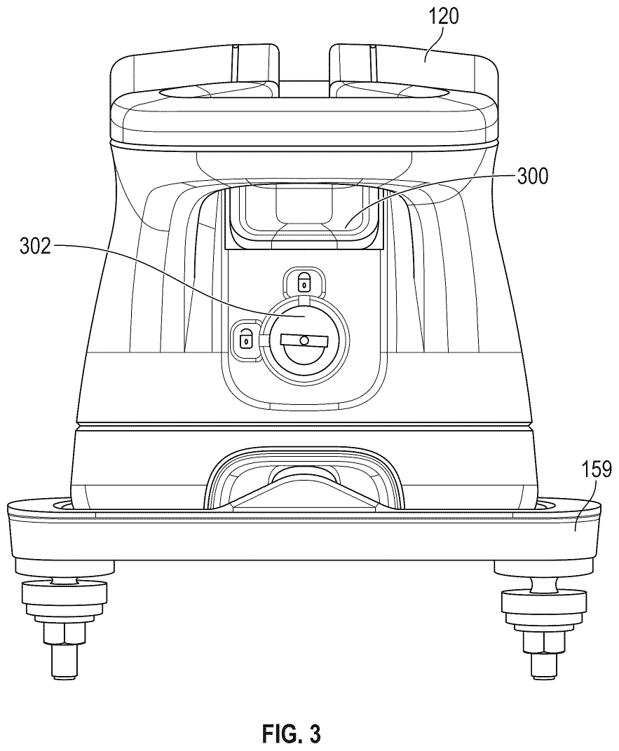

FIG. 3 illustrates a side view of an example crossbar 120 in accordance with one or more implementations. In the example of FIG. 3, the mechanical connector 159 may be (e.g., permanently) attached to the vehicle using bolts. In the example of FIG. 3, a paddle 300 of the crossbar 120 is shown in an open position. In the open position of FIG. 3, the paddle 300 may be pressed or pulled upward to operate a latch mechanism within the crossbar 120 to release the crossbar 120 from the mechanical connector, and/or pressed or pushed down operate the latch mechanism to latch or clamp the crossbar 120 to the mechanical connector 159, as described in further detail hereinafter. As shown, a lock 302 may be provided under the paddle 300. For example, the lock 302 may be switched from an unlocked position that allows the paddle 300 to be actuated up to release the crossbar 120 and/or down to latch the crossbar 120 to the mechanical connector 159.

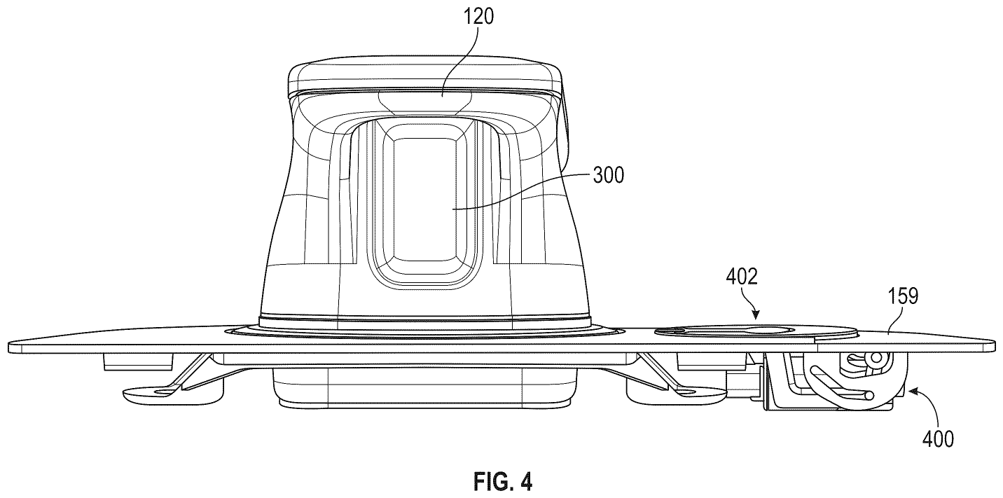

FIG. 4 illustrates a side view of another example crossbar in accordance with one or more implementations. In the example of FIG. 4, the mechanical connector 159 may include a mechanism 400 and a tab 402. For example, the mechanism 400 may be a release mechanism, and the tab 402 may be mechanically coupled to the release mechanism to release the mechanical connector 159 from the vehicle 100. In the example of FIG. 4, the paddle 300 is shown in a closed position. In the closed position of FIG. 4, the latching mechanism within the crossbar 120 clamps the crossbar 120 to the mechanical connector 159.

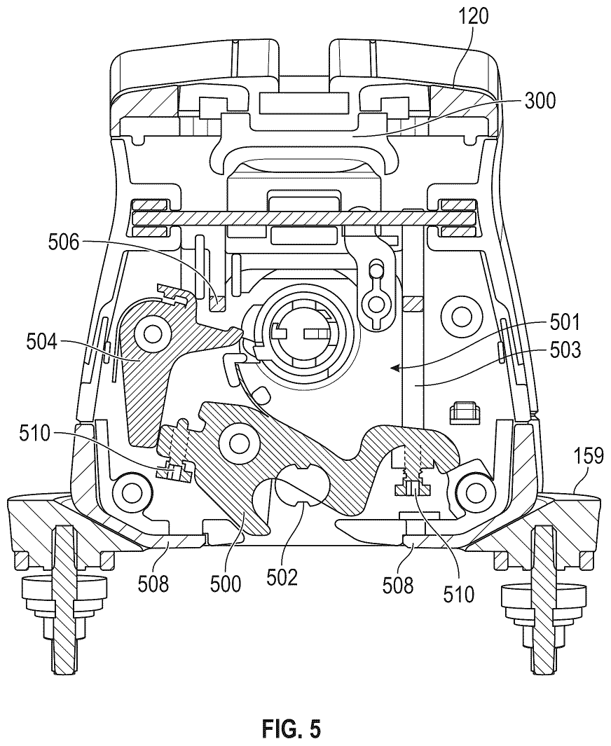

FIGS. 5, 6, and 7 show internal features of various latch mechanisms that may be included within the crossbar 120, and that may be actuated by the paddle 300 of FIGS. 3 and 4 to release and/or latch the crossbar 120 from and/or to the mechanical connector 159.

FIG. 5 illustrates a cross-sectional side view of the crossbar of FIG. 3 in accordance with one or more implementations. In the example, of FIG. 5, the crossbar 120 is shown in the same orientation as in FIGS. 3 and 4, and with a portion of the housing of the crossbar removed to show the latching mechanism 501. As shown, the crossbar 120 may include a latch mechanism 501 that is operable to releasably couple the crossbar to the mechanical connector 159 using a pawl 500 that interfaces with a striker bar 502 on the mechanical connector 159. In the example of FIG. 5, the latching mechanism 501 is shown in an unlatched configuration. In this example, moving the paddle downward may lift a structure 503 that is coupled to the paddle 300 and the pawl 500. The structure 503 may pull upward on one side of the pawl 500 until a locking structure 504 moves (e.g., snaps) into place to hold the pawl 500 in a latched position around the striker bar 502. Once latched, lifting the paddle 300 upward may move a protrusion 506 downward to rotate the locking structure 504 to allow the pawl 500 to move (e.g., snap) back into the unlatched position shown in FIG. 5.

In the example of FIG. 5, the pawl 500 may provide a limited amount of tolerance with respect to the clamping force of the latch mechanism 501 to the mechanical connector 159. For example, a sealing material 508 may be provided on the crossbar 120 to provide a sealed interface between the crossbar 120 and the mechanical connector 159 when the crossbar 120 is latched. The sealing material 508 may be a compliant material, that may change in thickness or compliance over time. In one or more implementations, one or more adjustment screws 510 may be provided for modifying the clamping force of the latching mechanism 501. However, it may be desirable to be able to provide a latching mechanism that incorporates an internal tolerance for the clamping force (e.g., to adjust for changes in thickness and/or compliance of the sealing material, without adjustments to the adjustment screws 510).

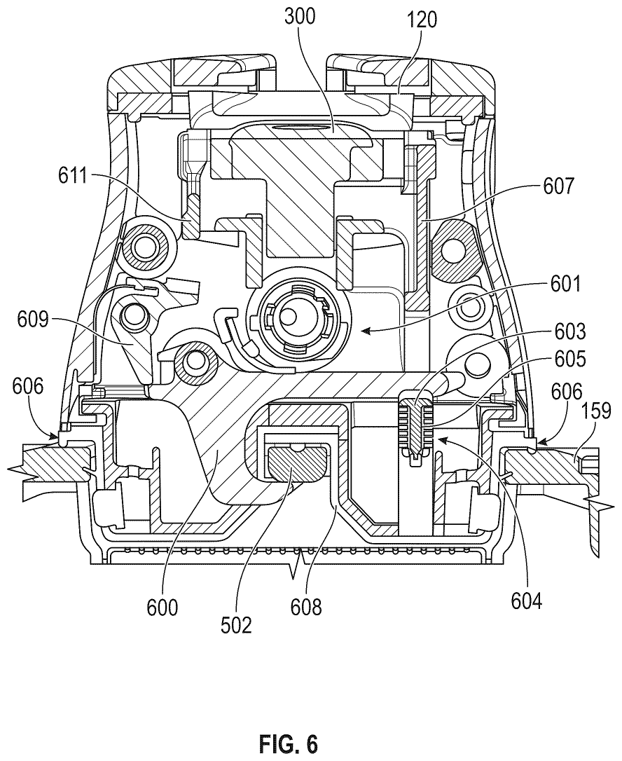

FIG. 6 illustrates a cross-sectional side view of the crossbar of FIG. 4 in an implementation in which the crossbar includes a latch mechanism 601. For example, the latch mechanism 601 may provide the crossbar 120 with additional clamping force tolerance, relative to that of the latch mechanism 501 of FIG. 5. In the example, of FIG. 6, the crossbar 120 is shown in the same orientation as in FIGS. 3 and 4, and with a portion of the housing of the crossbar removed to show the latch mechanism 601. As shown in FIG. 6, the crossbar 120 may releasably couple to the mechanical connector 159 using a pawl 600 that interfaces with the striker bar 502 on the mechanical connector 159.

In the example of FIG. 6, the latch mechanism 601 is shown in a latched configuration with a locking structure 609 holding the pawl 600 in a latched position around the striker bar 502. In this example, lifting the paddle 300 upward may move a protrusion 611 downward to rotate the locking structure 609 to allow the pawl 600 to rotate (e.g., snap) into an unlatched position. Once unlatched, moving the paddle 300 downward may lift a structure 607 that is coupled to the paddle 300 and/or the pawl 600. Moving the structure 607 upward may cause or allow one side of the pawl 600 to move upward while the other side of the pawl moves downward until the locking structure 609 rotates (e.g., snaps) into place to hold the pawl 600 in the latched position of FIG. 6.

In contrast with the implementation of FIG. 5, the crossbar 120 of FIG. 6 may include a spring assembly, such as a die spring and screw assembly 604 (e.g., including a spring 605 and a screw 603). For example, the die spring and screw assembly 604 may apply an upward force on the side of the pawl 600 that is away from the locking structure 609, along some or all of the range of motion of the pawl 600. In this way, the die spring and screw assembly 604 may provide benefits (e.g., relative to the implementation of FIG. 5), such as additional tolerance accommodation and/or a constant force being applied to the latch (e.g., including the pawl 600), such as over a range (e.g., a full range) of motion of the latch. In the example of FIG. 6, the same force may be provided at the paddle 300 to unlatch and latch the crossbar 120 to the mechanical connector 159 (e.g., due to the over center design of the system in FIG. 6). In the example of FIG. 6, a die spring and screw assembly 604 is used to, for example, provide a latching force tolerance for the pawl to releasably secure the crossbar to the mechanical connector. However, other configurations of latch assemblies are also possible, including using other spring assemblies in the latch mechanism.

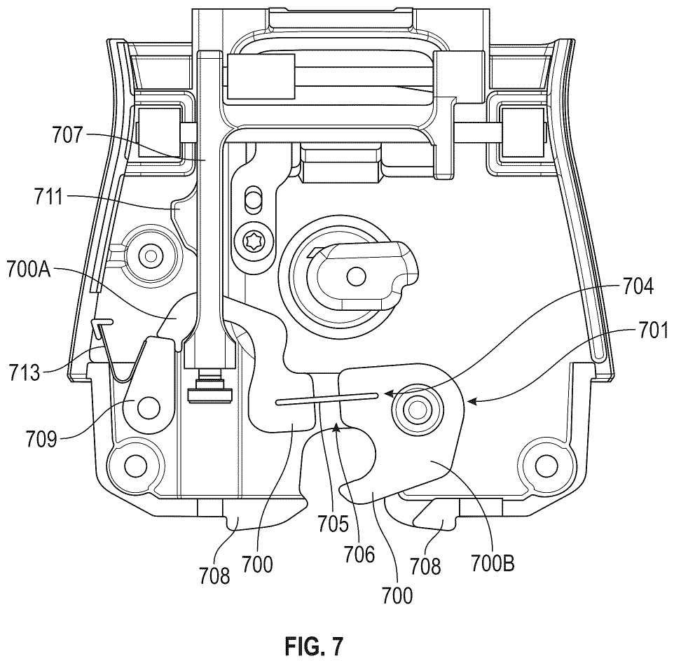

For example, FIG. 7 illustrates a cross-sectional side view of another example implementation of the crossbar of FIG. 4, in an implementation in which the crossbar includes a latch mechanism 701 with another spring assembly 704. For example, the latch mechanism 701 may also provide the crossbar 120 with additional clamping force tolerance, relative to that of the latch mechanism 501 of FIG. 5. In the example, of FIG. 7, the crossbar 120 is shown in an orientation opposite to the orientation shown in FIGS. 3 and 4. Although the striker bar 502 is not shown in FIG. 7, the crossbar 120 may releasably couple to the mechanical connector 159 using a pawl 700 that interfaces with the striker bar 502 on the mechanical connector 159.

In the example of FIG. 7, the latch mechanism 701 is shown in a latched configuration with a locking structure 709 holding the pawl 700 in a latched position (e.g., with a curved portion of the pawl 700 extending partially around the striker bar 502). As shown, an additional spring 713 may be provided in the latch mechanism 701 that biases the locking structure 709 toward the locked position shown in FIG. 7. In this example, lifting the paddle 300 upward may move a protrusion 711 downward to rotate the locking structure 709 (e.g., pushing against the biasing force of the additional spring 713) to allow the pawl 700 to move (e.g., snap) into an unlatched position. Once unlatched, moving the paddle 300 downward may lift a structure 707 (e.g., a structure 707 having the protrusion) that is coupled to the paddle 300 and/or the pawl 700. Moving the structure 707 upward may cause or allow a first portion 700A of the pawl 700 to move upward, which may rotate a second portion 700B of the pawl (e.g., around the striker bar 502) until the locking structure 709 rotates (e.g., snaps) into place to hold the first portion 700A of the pawl 700 in the latched position of FIG. 7.

As shown, the spring assembly 704 of FIG. 7 includes a leaf spring 705. As shown, the leaf spring 705 may couple a first portion 700A of the pawl 700 to the second portion 700B of the pawl 700. For example, the first portion 700A of the pawl 700 and the second portion 700B of the pawl 700 may be separated by a gap 706. The leaf spring 705 may span the gap 706, with a first end of the leaf spring 705 attached to first portion 700A of the pawl 700, and a second end of the leaf spring 705 attached to the second portion 700B of the pawl 700. In the latched configuration of FIG. 7, the leaf spring 705 may be flexed into a substantially flat shape. When the first portion 700A of the pawl 700 is released by the locking structure 709, the leaf spring 705 may contract into a curved (e.g., a wide U-shape), pulling the first portion 700A and the second portion 700B of the pawl 700 toward each other. In the flexed configuration shown in FIG. 7, the leaf spring 705 may exert a force on the second portion 700B of the pawl 700 that holds the second portion 700B against the striker bar of the mechanical connector 159, even if the relative positions of the pawl 700 and the striker bar vary (e.g., up to a range of flexure of the leaf spring).

In this way, the leaf spring 705 may provide a spring-loaded compliance in the pawl 700 that helps to provide a desired latching force even in different configurations of a scaling feature 708. For example, the leaf spring 705 may allow manufacturing variations in the sealing feature 708, and/or changes in compliance and/or thickness of the sealing feature 708 over time (e.g., due to wear) to be tolerated by the latch mechanism 701, without substantially changing the latching force with which the latch mechanism 701 latches the crossbar 120 to a vehicle (e.g., to a striker bar on the mechanical connector 159). For example, if the sealing feature 708 becomes more compressed over time, causing the striker bar to move away from the latching portion of the second portion 700B of the pawl 700, the leaf spring 705 may provide a force that compensates for that relative motion to maintain the latching force provided by the pawl 700.

As illustrated by FIGS. 1A-7, in one or more implementations, a crossbar 120 for a vehicle 100 may be provided. The crossbar 120 may include a pawl (e.g., pawl 600 or pawl 700) configured to interact with a striker bar 502 of a mechanical connector 159 on the vehicle 100 to releasably secure the crossbar 120 to the mechanical connector 159. The crossbar 120 may also include a spring assembly (e.g., die spring and screw assembly 604 of FIG. 6 or leaf spring 705 of FIG. 7) mechanically coupled to the pawl (e.g., to provide a spring force on a portion of the pawl). The crossbar 120 may also include one or more sealing features (e.g., sealing material 508, sealing features 606 and/or 608, or sealing features 708) configured to form a seal with the mechanical connector 159 when the crossbar 120 is mounted to the mechanical connector 159. For example, the one or more sealing features may include an outer sealing feature 606 (e.g., configured to form a first seal between the mechanical connector 159 and an outermost surface of the crossbar 120). The one or more sealing features may also include an inner sealing feature 608 (e.g., configured to form a second seal between the striker bar 502 of the mechanical connector 159 and another surface of the crossbar 120). As discussed herein, the spring assembly may be configured to provide a tolerance accommodation for mounting the crossbar 120 to the mechanical connector 159, and/or to allow a latch comprising the pawl to be latched and unlatched using a constant force over a range (e.g., a full range) of the latch.

In one or more implementations, a vehicle 100 may be provided, the vehicle 100 including a mechanical connector 159 having a striker bar 502. The vehicle 100 may also include a crossbar 120. The crossbar 120 may include a pawl (e.g., pawl 600 or pawl 700) configured to interact with the striker bar 502 of the mechanical connector 159 to releasably secure the crossbar 120 to the mechanical connector 159. The crossbar 120 may also include a spring assembly (e.g., die spring and screw assembly 604 of FIG. 6 or leaf spring 705 of FIG. 7) mechanically coupled to the pawl.

In one or more implementations, the latching force tolerance maintains a latching force for the pawl over a range of configurations of the one or more sealing features (e.g., due to mechanical variations in the sealing features and/or wear of the sealing features over time). In one or more implementations, the spring assembly may include a leaf spring 705. For example, the pawl may include a first portion 700A and a second portion 700B separate from the first portion, and the leaf spring 705 may couple the first portion 700A of the pawl to the second portion 700B of the pawl. In one or more implementations, the crossbar (e.g., the latching mechanism of the crossbar) may also include a locking structure 709 and an additional spring 713 that biases the locking structure 709 into a locked position that holds the pawl in a latched configuration (e.g., as shown in FIG. 7). In one or more implementations, the crossbar may also include a paddle 300 for controlling a latch mechanism 701 that includes the pawl, the spring assembly (e.g., spring assembly 704), the locking structure 709, and the additional spring 713. Moving the paddle when the pawl is in the latched configuration may move a protrusion 711 on a structure 707 that is mechanically coupled to the paddle into contact with the locking structure 709 to push the locking structure 709 away from the locked position, compressing the additional spring 713, until the pawl 700 is released into an unlatched configuration. In one or more implementations, the spring assembly is further configured to allow a latch comprising the pawl to be latched and unlatched using a constant force over a range of the latch.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A crossbar for a vehicle, the crossbar comprising:
a pawl configured to interact with a striker bar of a mechanical connector on the vehicle to releasably secure the crossbar to the mechanical connector; and
a spring assembly mechanically coupled to the pawl and configured to provide a latching force tolerance for the pawl to releasably secure the crossbar to the mechanical connector.

2. The crossbar of claim 1, further comprising one or more sealing features configured to form a seal with the mechanical connector when the crossbar is mounted to the mechanical connector, wherein the latching force tolerance maintains a latching force for the pawl over a range of configurations of the one or more sealing features.

3. The crossbar of claim 2, wherein one or more sealing features comprise:
an outer sealing feature configured to form a first seal between the mechanical connector and an outermost surface of the crossbar; and
an inner sealing feature configured to form a second seal between the striker bar of the mechanical connector and another surface of the crossbar.

4. The crossbar of claim 1, wherein the spring assembly comprises a spring and screw assembly.

5. The crossbar of claim 1, wherein the spring assembly comprises a leaf spring.

6. The crossbar of claim 5, wherein the pawl comprises a first portion and a second portion separate from the first portion, and wherein the leaf spring couples the first portion of the pawl to the second portion of the pawl.

7. The crossbar of claim 1, further comprising:
a locking structure; and
an additional spring that biases the locking structure into a locked position that holds the pawl in a latched configuration.

8. The crossbar of claim 7, further comprising a paddle for controlling a latch mechanism comprising the pawl, the spring assembly, the locking structure, and the additional spring, wherein moving the paddle when the pawl is in the latched configuration moves a protrusion on a structure that is mechanically coupled to the paddle into contact with the locking structure to push the locking structure away from the locked position, compressing the additional spring, until the pawl is released into an unlatched configuration.

9. The crossbar of claim 1, wherein the spring assembly is further configured to allow a latch comprising the pawl to be latched and unlatched using a constant force over a range of the latch.

10. A vehicle, comprising:
a mechanical connector having a striker bar; and
a crossbar comprising a latch mechanism comprising:
a pawl configured to interact with the striker bar of the mechanical connector to releasably secure the crossbar to the mechanical connector; and
a spring assembly mechanically coupled to the pawl and configured to provide a latching force tolerance for the pawl to releasably secure the crossbar to the mechanical connector.

11. The vehicle of claim 10, wherein the mechanical connector is mounted to a roof or a truck bed of the vehicle.

12. The vehicle of claim 10, the crossbar further comprising one or more sealing features configured to form a seal with the mechanical connector when the crossbar is mounted to the mechanical connector, wherein the latching force tolerance maintains a latching force for the pawl over a range of configurations of the one or more sealing features.

13. The vehicle of claim 10, wherein the spring assembly comprises a die spring and screw assembly.

14. The vehicle of claim 10, wherein the spring assembly comprises a leaf spring.

15. The vehicle of claim 14, wherein the pawl comprises a first portion and a second portion separate from the first portion, and wherein the leaf spring couples the first portion of the pawl to the second portion of the pawl.

16. The vehicle of claim 10, the latch mechanism further comprising:
a locking structure; and
an additional spring that biases the locking structure into a locked position that holds the pawl in a latched configuration.

17. The vehicle of claim 16, the crossbar further comprising a paddle for controlling the latch mechanism comprising the pawl, the spring assembly, the locking structure, and the additional spring, wherein moving the paddle when the pawl is in the latched configuration moves a protrusion on a structure that is mechanically coupled to the paddle into contact with the locking structure to push the locking structure away from the locked position, compressing the additional spring, until the pawl is released into an unlatched configuration.

18. The vehicle of claim 1, wherein the spring assembly is further configured to allow a latch comprising the pawl to be latched and unlatched using a constant force over a range of the latch.

19. A latching mechanism for a crossbar for a vehicle, the latching mechanism comprising:
a pawl configured to interact with a striker bar of a mechanical connector on the vehicle to releasably secure the crossbar to the mechanical connector; and
a spring assembly mechanically coupled to the pawl and configured to provide a latching force tolerance for the pawl to releasably secure the crossbar to the mechanical connector.

20. The latching mechanism of claim 19, wherein the pawl comprises a first portion and a second portion separate from the first portion, and wherein a leaf spring couples the first portion of the pawl to the second portion of the pawl.
